(19) United States
(12) Patent Application Publication
(10) Pub. No.: US 2012/0246902 A1
(43) Pub. Date: Oct. 4, 2012

(54) TRANSVERSE COMPRESSION TOOL

(75) Inventor: Noah Montena, Syracuse, NY (US)

(73) Assignee: JOHN MEZZALINGUA ASSOCIATES, INC., East Syracuse, NY (US)

(21) Appl. No.: 13/076,600

(22) Filed: Mar. 31, 2011

(51) Int. Cl. H01R 43/26; H02G 1/00; B25B 27/00

(52) U.S. Cl. 29/426.6; 29/244; 29/252; 29/764

(57) ABSTRACT

A compression tool positioned transverse to a coaxial cable, wherein the compression tool axially compresses a connector positioned on the coaxial cable while the compression tool remains transverse to the coaxial cable, wherein a plurality of linkages having a bended configuration translate transverse movement of an actuator to axial compression of at least two engagement heads. Furthermore, an associated method for providing axial compression is also provided.

### FIELD OF TECHNOLOGY

The following relates to compression tools used to secure grounding clamps or other compression connectors to coaxial cables in communication applications, and more specifically to embodiments of a transverse compression tool wherein the body of the tool is transverse to the coaxial cable.

### BACKGROUND

Broadband communications have become an increasingly prevalent form of electromagnetic information exchange and coaxial cables are common conduits for transmission of broadband communications. Coaxial cables are typically designed so that an electromagnetic field carrying communications signals exists only in the space between inner and outer coaxial conductors of the cables. This allows coaxial cable runs to be installed next to metal objects without the power losses that occur in other transmission lines, and provides protection of the communications signals from external electromagnetic interference. Grounding clamps are provided at mid-span locations to establish electrically ground connections at mid-span locations. Some grounding clamps and compression connectors are axially compressed to facilitate adequate grounding connections and create annular seals at the ends to prevent ingress of environmental pollutants. Often times, a compression tool provides the axial compression needed to facilitate grounding connections and seal the ends of the grounding clamps. However, compression tools currently available for compressing compression connectors and grounding clamps require that the compression connector or grounding clamp be unattached from equipment or other connectors because the existing compression tools press on components of the compression connectors along the central axis. This constraint precludes use with grounding clamps or other compression connectors that are already attached to the coaxial cable, for example, after installation.

Hence, a need exists for an improved compression tool that can be used on grounding clamps and compression connectors while already attached to equipment, such as a coaxial cable.

### SUMMARY

A first general aspect of the invention provides a compression tool comprising a first set of toggle linkages moveably connected to a first spacer at one end, wherein a first tool engagement head is moveably connected to a distal end of the first set of toggle linkages, a second set of toggle linkages moveably connected to a second spacer at one end, wherein a second tool engagement head is moveably connected to a distal end of the second set of toggle linkages, and an actuator moveably connected to the first spacer and the second spacer, wherein transverse movement of the actuator translates into axial movement of the first tool engagement head and the second tool engagement head, wherein the axial movement of the first tool engagement head and the second tool engagement head axially compresses a connector.

A second general aspect of the invention provides a compression tool comprising a plurality of linkages assembled over-center to translate transverse movement of an actuator to axial movement of at least two tool engagement heads, wherein the plurality of linkages are moveably connected to the at least two tool engagement heads and moveably connected to the actuator, wherein a majority of the compression tool is positioned transverse to a central axis of a connector attached to a coaxial cable while axially compressing the connector.

A third general aspect of the invention provides a device comprising a compression tool positioned transverse to a coaxial cable, wherein the compression tool axially compresses a connector positioned on the coaxial cable while the compression tool remains transverse to the coaxial cable, wherein a plurality of linkages having a bended configuration translate transverse movement of an actuator to axial compression of at least two engagement heads.

A fourth general aspect of the invention provides a method for axially compressing a compression type connector comprising providing a compression tool comprising, a first set of toggle linkages moveably connected to a first spacer at one end, wherein a first tool engagement head is moveably connected to a distal end of the first set of toggle linkages, a second set of toggle linkages moveably connected to a second spacer at one end, wherein a second tool engagement head is moveably connected to a distal end of the second set of toggle linkages, and an actuator moveably connected to the first spacer and the second spacer, wherein transverse movement of the plunger translates into axial movement of the first tool engagement head and the second tool engagement head, and actuating the actuator to generate axial movement of the first tool engagement head and the second tool engagement head to axially compress a connector.

The foregoing and other features of construction and operation of the invention will be more readily understood and fully appreciated from the following detailed disclosure, taken in conjunction with accompanying drawings.

### BRIEF DESCRIPTION OF THE DRAWINGS

Some of the embodiments of this invention will be described in detail, with reference to the following figures, wherein like designations denote like members, wherein:

FIG. 1 depicts a side view of an embodiment of an embodiment of a compression tool;

FIG. 2 depicts an exploded perspective view of a first embodiment of a compression tool;

FIG. 3 depicts a perspective view of an embodiment of a compression tool, wherein broken lines show hidden components; and

FIG. 4 depicts an exploded perspective of another embodiment of a compression tool.

### DETAILED DESCRIPTION

Although certain embodiments of the present invention are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

As a preface to the detailed description, it should be noted that, as used in this specification and the appended claims, the singular forms “a”, “an” and “the” include plural referents, unless the context clearly dictates otherwise.

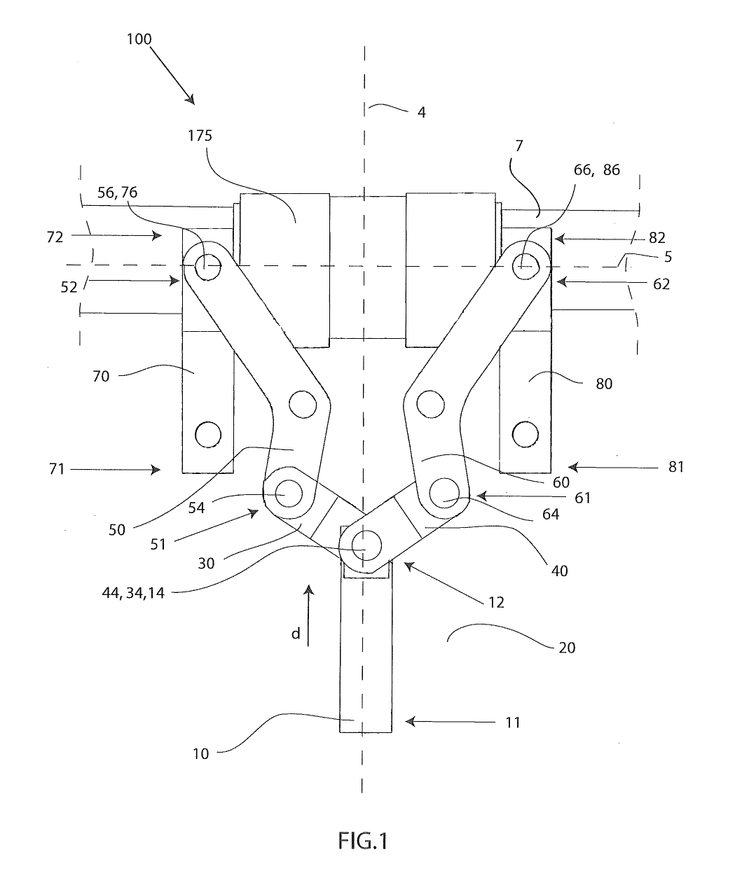

Referring to the drawings, FIG. 1 depicts one embodiment of a compression tool 100. Compression tool 100 may be used to axially compress a connector 175 attached to a coaxial cable 7 or other equipment. Connector 175 may be a compression connector, splice connector, grounding clamp, or any connector device responsive to axial compression. Those having skill in the art should appreciate that compression tool 100 may also axially compress a connector which is unattached to the cable 7 or to other equipment. Furthermore, compression tool 100 axially compresses the connector 175 with the majority of the tool positioned transverse to the coaxial cable 7. For instance, the majority of the compression tool 100 may be below, above, or any position substantially transverse to the coaxial cable 7, or a central axis 5 of the connector 175 while engaging one or more ends of the connector 175. Because a majority of the compression tool 100 is transverse to the cable 7, a connector 175 may be axially compressed after installation onto a cable 7, without the coaxial cable 7, other equipment, or connector components acting as physical constraints. Therefore, compression tool 100 may provide unimpeded access to the ends or shoulders of the connector 175. For example, compression tool 100 may axially compress a compression connector which is already connected at the interface, a compression type grounding clamp with coaxial cable 7 entering at both ends, and a splice connector also having coaxial cable 7 entering at both ends.

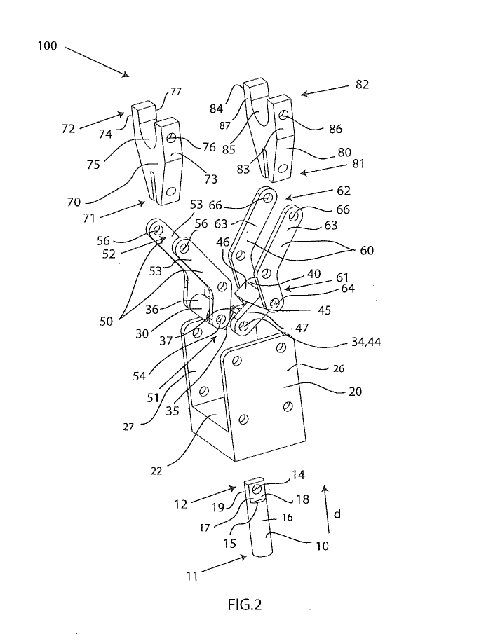

With reference now to FIG. 2, an embodiment of a compression tool 100 may include a first set of toggle linkages 50, a second set of toggle linkages 60, a first spacer 30, a second spacer 40, an actuator 10, a first tool head 70, a second tool head 80, and a base member 20. In another embodiment, a compression tool 100 may include a first set of toggle linkages 50 moveably connected to a first spacer 30 at one end 51, wherein a first tool engagement head 70 is moveably connected to a distal end 52 of the first set of toggle linkages 50, a second set of toggle linkages 60 moveably connected to a second spacer 40 at one end 61, wherein a second tool engagement head 80 is moveably connected to a distal end 62 of the second set of toggle linkages 60, and an actuator 10 moveably connected to the first spacer 30 and the second spacer 40, wherein transverse movement of the actuator 10 translates into axial movement of the first tool engagement head 70 and the second tool engagement head 80, wherein the axial movement of the first tool engagement head 70 and the second tool engagement head 80 axially compresses a connector 175.

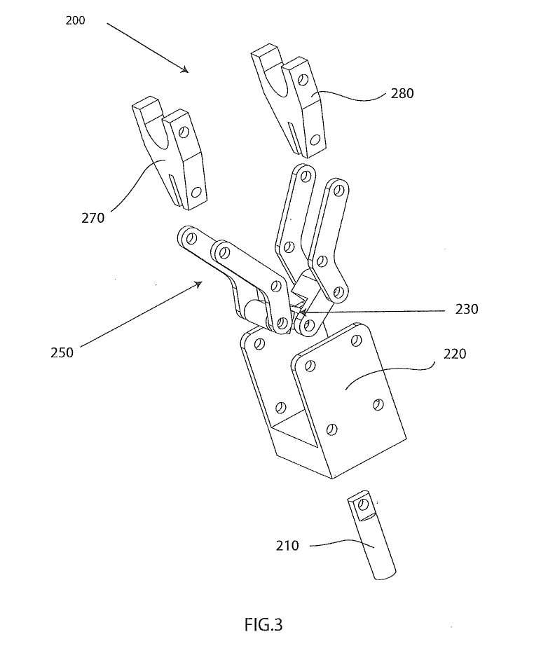

Referring to FIG. 3, another embodiment of compression tool 100 may include a plurality of linkages 250 assembled over-center to translate transverse movement of an actuator 210 to axial movement of at least two tool engagement heads 270, 280, wherein the plurality of linkages 250 are moveably connected to the at least two tool engagement heads 270, 280 and moveably connected to the actuator 210, wherein a majority of the compression tool 100 is positioned transverse to a central axis 5 of a connector 275 attached to a coaxial cable 7 while axially compressing the connector 275. In yet another embodiment, compression tool 100 may be positioned transverse to a coaxial cable 7, wherein the compression tool 100 axially compresses a connector 175 positioned on the coaxial cable 7 while the compression tool 100 remains transverse to the coaxial cable 7, wherein a plurality of linkages 250 having a bended configuration translate transverse movement of an actuator 210 to axial compression of at least two engagement heads 270, 280.

Referring back to FIG. 2, the first set of toggle linkages 50 of embodiments of compression tool 100 has a first end 51 and a distal second end 52. The first set of toggle linkages 50 may be moveably connected to a first spacer 30 proximate or otherwise near the first end 51, and moveably connected to a first tool engagement head 70 proximate or otherwise near the distal second end 52. The first set of toggle linkages 50 may comprise at least two individual linkages 53 sharing a substantially identical bend angle. For instance, the first set of linkages 50 may be two or more linkages 53 spaced apart by a first spacer 30, and having an identical bend angle suitable for translating transverse movement of a tool plunger 10 to axial movement of tool engagement head 70. Linkages 53 may be substantially flat members having a bended configuration. In many embodiments, linkages 53 may have a generally obtuse bend angle, or bended configuration. Furthermore, linkages 53 may have a plurality of openings positioned thereon, wherein the plurality of openings are substantially aligned with openings positioned on other linkages 53 in the first set of toggle linkages 50 to ensure even alignment with other components of compression tool 100. In particular, linkage 53 may include opening 56, configured to align with opening 76 of the first tool engagement head 70, and opening 54, configured to align with hole 34 of the first spacer 30. Linkage 53 may include additional openings to allow for modularity, size adjustment, or angle adjustment. The plurality of openings (e.g. openings 54, 56) may accept or receive a fastening member 90, such as a pin or crossbar to moveably connect the linkages 53 to a first spacer 30 at a first end 51, and to a first tool engagement head 70 at the second end 52. Those having skill in the art should appreciate that various connection means may be used to moveably connect the components of compression tool 100.

With continued reference to FIG. 2, the second set of toggle linkages 60 of embodiments of compression tool 100 has a first end 61 and a distal second end 62. The second set of toggle linkages 60 may be moveably connected to a second spacer 40 proximate or otherwise near the first end 61, and moveably connected to a second tool engagement head 80 proximate or otherwise near the distal second end 62. The second set of linkages 60 may comprise at least two individual linkages 63 sharing a substantially identical bend angle. For instance, the second set of linkages 60 may be two or more linkages 63 spaced apart by a second spacer 40, and having an identical or substantially identical bend angle suitable for translating transverse movement of a tool plunger 10 to axial movement of tool engagement head 80. Linkages 63 may be flat or substantially flat members having a bended configuration. In many embodiments, linkages 63 may have a generally obtuse bend angle, or a bended configuration. Furthermore, linkages 63 may have a plurality of openings positioned thereon, wherein the plurality of openings are substantially aligned with openings positioned on other linkages 63 in the second set of toggle linkages 60 to ensure even alignment with other components of compression tool 100. In particular, linkage 63 may include opening 66 positioned proximate or otherwise near the second end 62, configured to align with opening 86 of the second tool engagement head 80, and opening 54 positioned proximate or otherwise near the first end 61, configured to align with hole 44 of the second spacer 40. Linkage 63 may include additional openings to allow for modularity, size adjustment, or angle adjustment. The plurality of openings (e.g. openings 64, 66) may accept or receive a fastening member 90, such as a pin or crossbar to moveably connect the linkages 63 to a second spacer 40 at a first end 61, and to a second tool engagement head 80 at a second end 62. Those having skill in the art should appreciate that various connection means may be used to moveably connect the components of compression tool 100.

In most embodiments, linkages 53 and linkages 63 share the same dimensions, including thickness, shape, length, etc. In other words, linkages 53, 63 may be used interchangeably in the first and second sets of toggle linkages 50, 60. For instance, linkages 53 used to form the first set of toggle linkages 50 could also be used to form the second set of toggle linkages 60. However, while operably configured, linkages 63 used to form the second set of toggle linkages 60 may have a reflective relationship with linkages 53 forming the first set of toggle linkages 50. Moreover, linkages 53, 63 may be connection members, toggle linkages, links, pivot links, toggle bars, bars, chain-members, assembly members, and the like. Linkages 53, 63 may have a plurality of openings to facilitate moveable connections to other components of compression tool 100. Openings 33, 34, 43, 44, 54, 56, 64, 66, 76, and 86 may be receptive to a mechanical fastening member 90, and may also be a toggle joint, junction point, connection point, joint, fastening point, opening, hole, access point, keyway, or any device structured to facilitate moveable connections between the components of compression tool 100. In many embodiments, a mechanical connection means, such as fastening member 90 inserted through an opening or hole and securably attached at one or both ends, can be used to moveably connect the components of compression tool 100. Fastening member 90 may be a rigid, generally cylindrical member, such as a pin, rod, crossbar, stem, and the like.

Referring again to FIG. 2, embodiments of a compression tool 100 may also include a first spacer 30 positioned proximate a first end 51 of the first set of toggle linkages 50. Additionally, the first spacer 30 may be positioned proximate or otherwise near the second end 12 of the actuator 10. The first spacer 30 is rigid member having a first end 31 and a second end 32. The first spacer 30 may include a notch 35 positioned proximate or otherwise near the second end 32 to provide clearance for a portion of the second spacer 40 during movement of the components of compression tool 100. For example, when the actuator 10 is actuated, the first and second spacers 30, 40 uniformly and simultaneously move; notch 35 provides clearance for a portion of the second spacer 40. Notch 35 may be a void, space, or opening representing a hypothetically removed portion of the first spacer 30. In another embodiment, the first spacer 30 may include a body member 36 and a flat, protruding surface 37 extending from the body member 36. Positioned on the first spacer 30, in particular, surface 37 may be an opening 33, wherein opening 33 is aligned with opening 43 of the second spacer 40 and opening 13 of actuator 10 to moveably connect the first spacer 30, the second spacer 40, and actuator 10.

Furthermore, the first spacer 30 may space apart linkages 53 of the first set of toggle linkages 50, usually a distance substantially equal to the width of the first tool engagement head 70. The first spacer 30 also constructively connects an individual linkage 53 to another individual linkage 53 to form the first set of toggle linkages 50. For example, two linkages 53 may be moveably connected to the first spacer 30, in particular, one linkage 53 may be moveably connected at one side of the body member 36 of the first spacer 30, and another linkage 53 may be moveably connected at the opposite side of the body member 36 of the first spacer 30. The distance each linkage 53 is spaced apart from each other depends on the width of the first spacer 30. In most embodiments, the width of the first spacer 30 is approximately equal to the width of the first tool engagement head 70. In another embodiment, the width of the first spacer 30 should be proportional to the size and/or diameter of the coaxial cable 7 extending along central axis 5. The first set of toggle linkages 50 may be moveably connected to the first spacer 30 by mechanical means, such as fastening member 90 inserted through an opening 54 positioned on a first linkage 53, through a hole 34 on the first spacer 30, and then through an aligned opening 54 on a second linkage 53. Hole 34 may be positioned on the body member 36 of the first spacer 30, and may be a tunnel, channel, opening, bore, or any void configured to accept a mechanical connection device, such as fastening member 90. Those having skill in the art should appreciate that various connection means may be used to moveably connect the components of compression tool 100.

Embodiments of a compression tool 100 may also include a second spacer 40 positioned proximate a first end 61 of the second set of toggle linkages 60. Additionally, the second spacer 40 may be positioned proximate or otherwise near the second end 12 of the actuator 10. The second spacer 40 is rigid member having a first end 41 and a second end 42. The second spacer 40 may include a notch 45 positioned proximate or otherwise near the second end 42 to provide clearance for a portion of the first spacer 30 during movement of the components of compression tool 100. For example, when the actuator 10 is actuated, the first and second spacers 30, 40 uniformly and simultaneously move; notch 45 provides clearance for a portion of the first spacer 30. Notch 45 may be a void, space, or opening representing a hypothetically removed portion of the second spacer 40. In another embodiment, the second spacer 40 may include a body member 46 and a flat, protruding surface 47 extending from the body member 46. Positioned on the second spacer 40, in particular, on surface 47 may be an opening 43, wherein opening 43 is aligned with opening 33 of the first spacer 30 and opening 13 of actuator 10 to moveable connect the first spacer 30, the second spacer 40, and actuator 10.

Furthermore, the second spacer 40 may space apart linkages 63 of the second set of toggle linkages 60, usually a distance substantially equal to the width of the second tool engagement head 80. The second spacer 40 also constructively connects an individual linkage 63 to another individual linkage 63 to form the second set of toggle linkages 60. For example, two linkages 63 may be moveably connected to the second spacer 40, in particular, one linkage 63 may be moveably connected at one side of the body member 46 of the second spacer 40, and another linkage 63 may be moveably connected at the opposite side of the body member 46 of the second spacer 40. The distance each linkage 63 is spaced apart from each other depends on the width of the second spacer 40. In most embodiments, the width of the second spacer 40 is approximately equal to the width of the second tool engagement head 80. In another embodiment, the width of the second spacer 40 should be proportional to the size and/or diameter of the coaxial cable 7 extending along central axis 5. The second set of toggle linkages 60 may be moveably connected to the second spacer 40 by mechanical means, such as fastening member 90 inserted through an opening 64 positioned on a first linkage 63, through a hole 44 on the second spacer 40, and then through an aligned opening 64 on a second linkage 63. Hole 44 may be positioned on the body member 46 of the second spacer 40, and may be a tunnel, channel, opening, bore, or any void configured to accept a mechanical connection device, such as fastening member 90. Those having skill in the art should appreciate that various connection means may be used to moveably connect the components of compression tool 100.

Referring still to FIG. 2, an actuator 10 having a first end 11 and a distal second end 12 may be moveably connected to the first spacer 30 and the second spacer 40 to actuate axial compression of the first and second tool engagement heads 70, 80. In most embodiment, the actuator 10 is moveably connected to the first and second spacers 30, 40 at the same location, for example, when opening 14 aligns with hole 34 and hole 44 of the first and second spacers 30, 40, respectively. The actuator 10 may be a generally rigid, elongate member, such as a cylinder or rectangle, having a notch 15 positioned proximate or otherwise near the second end 12. Notch 15 may be a void, space, or opening representing a hypothetically removed portion of the actuator 10. In another embodiment, the actuator 10 may include a body member 16 and a flat, protruding surface 17 extending from the body member 16. Notch 15 can provide clearance for a portion of the first and second spacer 30, 40 to reside while moveably connected. For example, a portion of the second spacer 40 may reside or be adjacently positioned along the first side 18 of flat surface 17 of actuator 10 while moveably connected. Additionally, a portion of the first spacer 30 may reside or be adjacently positioned along a second side 19 of flat surface 17 of actuator 10 while moveably connected. Those skilled in the art should appreciate that a portion of the first spacer 30 may reside or be adjacently positioned along the first side 18 of flat surface 17, while a portion of the second spacer 40 resides or is adjacently positioned along the second side 19 of surface 17. Positioned on the actuator 10, in particular, on surface 17 may be an opening 14 configured to accept a mechanical connection device, such as fastening member 90. To moveably connect the actuator 10 to the first spacer 30 and the second spacer 40, openings 34, 44, and 14 should be aligned to accept a mechanical connector, such as fastening member 90. Insertion of fastening member 90, or other mechanical fastening member, moveably connects the first spacer 30, the second spacer 40, and actuator 10 at the same point (i.e. same toggle joint), such that movement of either component translates to movement of the other components. For example, if actuator 10 is moved in direction, d, the first and second spacer 30, 40 should also move and/or pivot, but not detach from each other. Those having skill in the art should appreciate that various connection means may be used to moveably connect the components of compression tool 100.

With continued reference to FIG. 2, a first tool engagement head 70 having a first end 71 and a second end 72 is moveably connected to the first set of toggle linkages 50, proximate or otherwise near the second end 52 of the first set of toggle linkages 50. The first tool engagement head 70 may include a cradle 75 proximate or otherwise near the second end 72 of the tool engagement head 70 to allow a coaxial cable 7, parts of connector 175, or other equipment, to pass through without substantial interference. Cradle 75 may be a generally curved, or U-shaped, opening in the first tool engagement head 70, configured to accommodate a portion of a coaxial cable 7, or a portion of connector 175. The dimensions of the cradle 75 may correspond to the diameter of the coaxial cable 7, or correspond to the size and shape of the components of connector 175 that need to be avoided while contacting an end portion of the connector 175. In one embodiment, the first tool engagement head 70 may include a boss in the center to engage the interface of a standard connector in the conventional manner.

Moreover, the first tool engagement head 70 is a rigid member, and has an engagement surface 77 configured to mechanically engage an end, shoulder, edge, etc., of connector 175 to axially compress connector 175. For example, the first tool engagement head 70 should move in an axial direction towards the connector 175 if the actuator 10 is engaged or actuated. The axial movement of the first tool engagement head 70 occurs because it is moveably connected to the first set of toggle linkages 50, which are moveably connected to a first spacer 30, which is moveably connected to the actuator 10. In many embodiments. an opening 76 is positioned on each outer edge 73, 74 of the first tool engagement head 70, wherein opening 76 positioned on outer edge 73 is aligned with opening 56 of a first linkage 53 of the first set of toggle linkages 50, and another opening 76 positioned on outer edge 74 is aligned with another opening 56 on a second linkage 53 of the first set of toggle linkages 50. The first tool engagement head 70 may be disposed between the linkages 53 forming the first set of toggle linkages 50. Once the openings 56, 76 are aligned, a mechanical connection member, such as fastener member 90, may be inserted through the openings 56, 76 to moveably connect the first tool engagement head 70 to the first set of toggle linkages 50. Those having skill in the art should appreciate that various connection means may be used to moveably connect the components of compression tool 100.

Referring still to FIG. 1, a second tool engagement head 80 having a first end 81 and a second end 82 is moveably connected to the second set of toggle linkages 60, proximate or otherwise near the second end 62 of the second set of toggle linkages 60. The second tool engagement head 80 may include a cradle 85 proximate or otherwise near the second end 82 of the second tool engagement head 80 to allow a coaxial cable 7, parts of connector 175, or other equipment, to pass through without substantial interference. Cradle 85 may be a generally curved, or U-shaped, opening in the second tool engagement head 80, configured to accommodate a portion of a coaxial cable 7, or a portion of connector 175. The dimensions of the cradle 85 may correspond to the diameter of the coaxial cable 7, or correspond to the size and shape of the components of connector 175 that need to be avoided while contacting an end portion of the connector 175. In one embodiment, the second tool engagement head 80 may include a boss in the center to engage the interface of a standard connector in the conventional manner

Moreover, the second tool engagement head 80 is a rigid member, and has an engagement surface 87 configured to mechanically engage an end, shoulder, edge, etc., of connector 175 to axially compress connector 175. For example, the second tool engagement head 80 should move in an axial direction towards the connector 175 if the actuator 10 is engaged or actuated. The axial movement of the second tool engagement head 80 occurs because it is moveably connected to the second set of toggle linkages 60, which are moveably connected to a second spacer 40, which is moveably connected to the actuator 10. In many embodiments, an opening 86 is positioned on each outer edge 83, 84 of the second tool engagement head 80, wherein opening 86 positioned on outer edge 83 is aligned with opening 66 of a first linkage 63 of the second set of toggle linkages 60, and another opening 86 positioned on outer edge 84 is aligned with another opening 66 on a second linkage 63 of the second set of toggle linkages 60. The second tool engagement head 80 may be disposed between the linkages 63 forming the second set of toggle linkages 60. Once the openings 66, 86 are aligned, a mechanical connection member, such as fastener member 90, may be inserted through the openings 66, 86 to moveably connect the second tool engagement head 80 to the second set of toggle linkages 60. Those having skill in the art should appreciate that various connection means may be used to moveably connect the components of compression tool 100.

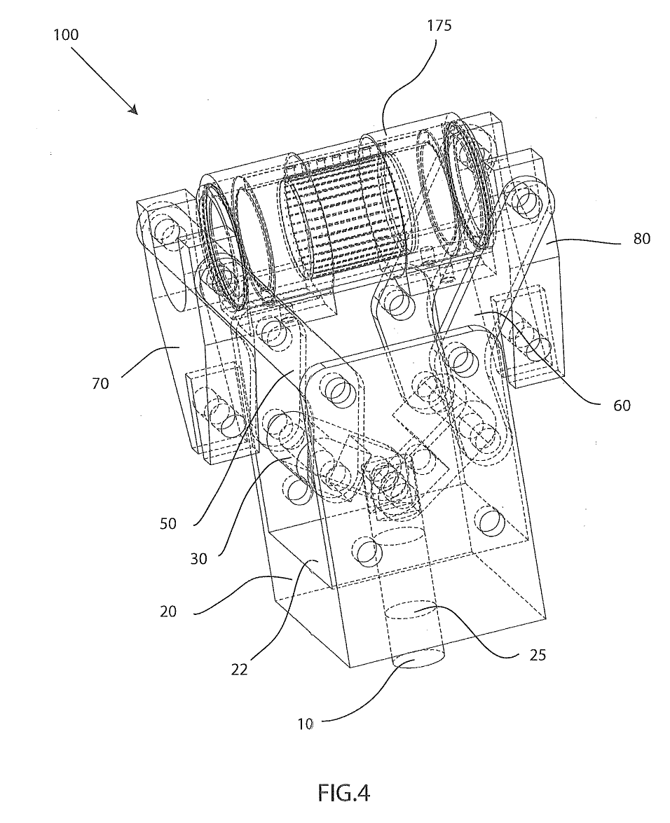

Embodiments of a compression tool 100 may also include a base member 20 positioned over the first and second spacers 30, 40, and a portion of the first and second sets of toggle linkages 50, 60. In other words, the base member 20 may be positioned over the center of the compression tool 100. Base member 20 may be a cover, a base, casing, substructure, support, channel, holder, or any member configured to provide mechanical support to the assembly of the components of compression tool 100. Base member 20 may also function as a protective cover for the moving components of compression tool 100 to prevent injury to a person operating the compression tool 100, or to prevent the components from damage. Additionally, the base member 20 may function as a gripping area or holding device to assist in holding and/or operating the compression tool 100. Furthermore, an opening 25 may be positioned somewhere on the bottom surface 22 of the base member 20 to allow actuator 10 to pass through to moveably connect to the first and second spacers 30, 40, as embodied in FIG. 4. In one embodiment, opening 25 should be positioned at the center of the bottom surface 22 of the base member 20. In another embodiment, base member 20 may also include a first side wall 26 and a second side wall 27. In another embodiment, base member 20 may include two or more side walls to form an enclosure around a portion of the compression tool 100, wherein the base member 20 does not have a top surface. Moreover, a plurality of openings may be positioned on the first and second side walls 26, 27 to allow any add-on or extra equipments or components to be moveably or securably attached to the base member 20, or to allow one or more components of compression tool 100 to be moveably or securably attached to the base member 20.

Turning now to FIGS. 1-4, the manner in which is the compression tool 100 axially compresses a connector 175 is now described. Transverse movement of the actuator 10 in direction, d, engages the first and second spacers 30, 40 because they are moveably connected, for example, by a mechanical connection member, such as fastening member 90. When the actuator engages the first spacer 30, the first spacer 30 rotates, pivots, or moves, such that the first set of toggle linkages 50 changes position and/or orientation because the first spacer 30 is moveably connected to the first set of toggle linkages 50. Concurrently, the actuator 10 engages the second spacer 40, rotating, pivoting, or moving the second spacer 40 such that the second set of toggle linkages 60 changes position because the second spacer 40 is moveably connected to the second set of toggle linkages 60. In particular, both the first set of toggle linkages 50 and second set of toggle linkages 60 may move towards transverse axis 4 when actuator 10 is moved in direction, d. In other words, the distance between the first set of toggle linkages 50 and the second set of toggle linkages 60 may be decreased as the actuator 10 is moved in direction, d. The movement of the first set of toggle linkages 50 translates to axial movement of the first tool engagement head 70 towards the connector (or clamp) 175 (i.e. towards transverse axis 4) because they are moveably connected. Similarly, the movement of the second set of toggle linkages 60 translates to axial movement of the second tool engagement head 80 towards the connector (or clamp) 175 (i.e. towards transverse axis 4) because they are moveably connected. Due to the bended configuration of linkages 53, 63 and the moveable connections between the components of compression tool 100, the transverse mechanical forces exerted onto the linkages 53, 63 by movement of the actuator 10 are translated to axial mechanical forces exerted onto the tool engagement heads 70, 80. Therefore, the tool engagement heads 70, 80 move in an axial direction to axially compress the connector 175. In one exemplary embodiment, the actuator 10 is hydraulically or pneumatically actuated. In another embodiment, the actuator 10 is actuated by a screw mechanism, electrically driven or mechanically driven by hand. In another embodiment, the actuator 10 is actuated by lever. Those skilled in the art should appreciate that actuator 10 may be actuated by any convenient mode of force multiplication or automation.

Referring back to FIG. 3, further embodiments of compression tool 200 may include a plurality of linkages 250 assembled over-center to translate transverse movement of an actuator 210 to axial movement of tool engagement heads 270, 280. For example, a plurality of over-center toggle linkages 250 may be moveably connected to tool engagement heads 270, 280 to translate transverse movement of the actuator 210 into axial movement of the tool engagement heads 270, 80, wherein the plurality of over-center toggle linkages 250 are moveably connected to the actuator 210. Moreover, compression tool 200 may include at least two spacers 230 spacing apart each of the plurality of linkages 250, wherein the at least two spacers 230 are moveably connected to the actuator 210, and a base member 220 positioned over a portion of the compression tool 200.

Referring again to FIGS. 1-4, a method for providing axial compression (e.g. axially compressing a compression type connector or mid-span clamp) 175 may comprise the steps of providing a compression tool 100 comprising, a first set of toggle linkages 50 moveably connected to a first spacer 30 at one end 51, wherein a first tool engagement head 70 is moveably connected to a distal end 52 of the first set of toggle linkages 50, a second set of toggle linkages 60 moveably connected to a second spacer 40 at one end 61, wherein a second tool engagement head 80 is moveably connected to a distal end 62 of the second set of toggle linkages 60, and an actuator 10 moveably connected to the first spacer 30 and the second spacer 30, wherein transverse movement of the actuator 10 translates into axial movement of the first tool engagement head 70 and the second tool engagement head 80, and actuating the actuator 10 to generate axial movement of the first tool engagement head 70 and the second tool engagement 80 head to axially compress a connector 175. The connector 175 of the method may be a compression type connector, splice connector, or grounding clamp. Moreover, the first set of toggle linkages 50 includes two linkages 53 spaced apart by the first spacer 30, further wherein the two linkages 53 have a bended configuration. Similarly, the second set of toggle linkages 60 includes two linkages 63 spaced apart by the second spacer 40, further wherein the two linkages 63 have a bended configuration. In one exemplary embodiment of the method, the actuator 10 is hydraulically actuated. In another embodiment of the method, the actuator 10 is actuated by a screw mechanism, electrically driven or mechanically driven by hand. In another embodiment of the method, the actuator 10 is actuated by lever. Those skilled in the art should appreciate that actuator 10 may be actuated by any convenient mode of force multiplication or automation.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

What is claimed is:

1. A compression tool comprising:
a first set of toggle linkages moveably connected to a first spacer at one end, wherein a first tool engagement head is moveably connected to a distal end of the first set of toggle linkages;
a second set of toggle linkages moveably connected to a second spacer at one end, wherein a second tool engagement head is moveably connected to a distal end of the second set of toggle linkages; and
an actuator moveably connected to the first spacer and the second spacer, wherein transverse movement of the actuator translates into axial movement of the first tool engagement head and the second tool engagement head.

2. The compression tool of claim 1, wherein the axial movement of the first tool engagement head and the second tool engagement head is configured to axially compresses at least one of a connector and a clamp.

3. The compression tool of claim 1, wherein the first tool engagement head and second tool engagement head have a cradle allowing a coaxial cable to pass through while simultaneously engaging ends of at least one of the connector and the clamp.

4. The compression tool of claim 1, wherein the actuator actuates the first and second set of toggle linkages through an opening positioned on a bottom surface of a base member, further wherein the base member covers a portion of the compression tool.

5. The compression tool of claim 1, wherein the first set of toggle linkages includes two linkages spaced apart by the first spacer, further wherein the two linkages have a bended configuration.

6. The compression tool of claim 1, wherein the second set of toggle linkages includes two linkages spaced apart by the second spacer, further wherein the two linkages have a bended configuration.

7. The compression tool of claim 1, wherein the actuator is hydraulically actuated.

8. A compression tool comprising:
a plurality of linkages assembled over-center to translate transverse movement of an actuator to axial movement of at least two tool engagement heads, wherein the plurality of linkages are moveably connected to the at least two tool engagement heads and moveably connected to the actuator;
wherein a majority of the compression tool is positioned transverse to a central axis of a connector attached to a coaxial cable while axially compressing the connector.

9. The compression tool of claim 8, further comprising:
at least two spacers spacing apart each of the plurality of linkages, wherein the at least two spacers are moveably connected to the actuator; and
a base member positioned over a portion of the compression tool.

10. The compression tool of claim 8, wherein the at least two tool engagement heads axially compress the connector.

11. The compression tool of claim 8, wherein the connector is at least one of a compression type connector and a mid-span clamp.

12. The compression tool of claim 8, wherein the plurality of linkages are moveably connected to the at least two tool engagement heads by a fastening member inserted through an opening positioned on each of the plurality of linkages and the at least two engagement heads.

13. A device comprising:
a compression tool positioned transverse to a coaxial cable, wherein the compression tool axially compresses a connector positioned on the coaxial cable while the compression tool remains transverse to the coaxial cable;
wherein a plurality of linkages having a bended configuration translate transverse movement of an actuator to axial compression of at least two engagement heads.

14. The device of claim 13, wherein the connector is at least one of a compression style connector, a splice connector, and a mid span grounding clamp.

15. The device of claim 13, wherein the plurality of linkages are moveably connected to the actuator and the at least two engagement heads.

16. A method for providing axial compression comprising:
providing a compression tool comprising, a first set of toggle linkages moveably connected to a first spacer at one end, wherein a first tool engagement head is moveably connected to a distal end of the first set of toggle linkages;
a second set of toggle linkages moveably connected to a second spacer at one end, wherein a second tool engagement head is moveably connected to a distal end of the second set of toggle linkages; and
an actuator moveably connected to the first spacer and the second spacer, wherein transverse movement of the actuator translates into axial movement of the first tool engagement head and the second tool engagement head; and
actuating the actuator to generate axial movement of the first tool engagement head and the second tool engagement head to axially compress a connector.

17. The method of claim 16, wherein the connector is at least one of a compression type connector, a splice connector, and a clamp.

18. The method of claim 16, wherein the first set of toggle linkages includes two linkages spaced apart by the first spacer, further wherein the two linkages have a bended configuration.

19. The method of claim 16, wherein the second set of toggle linkages includes two linkages spaced apart by the second spacer, further wherein the two linkages have a bended configuration.

20. The method of claim 16, wherein actuating the actuator is done hydraulically.
